(19) United States
(12) Patent Application Publication
(10) Pub. No.: US 2015/0316863 A1
(43) Pub. Date: Nov. 5, 2015

(54) ELECTROPHOTOGRAPHIC PHOTOSENSITIVE MEMBER, PROCESS CARTRIDGE AND ELECTROPHOTOGRAPHIC APPARATUS, AND GALLIUM PHTHALOCYANINE CRYSTAL

(71) Applicant: CANON KABUSHIKI KAISHA, Tokyo (JP)

(72) Inventors: Masato Tanaka, Tagata-gun (JP); Tsutomu Nishida, Mishima-shi (JP); Masataka Kawahara, Mishima-shi (JP); Junpei Kuno, Mishima-shi (JP)

(21) Appl. No.: 14/680,040

(22) Filed: Apr. 6, 2015

(30) Foreign Application Priority Data
Apr. 30, 2014 (JP) 2014-094022

(51) Int. Cl. G03G 5/06; C07F 5/00

(52) U.S. Cl. CPC G03G 5/0662; C07F 5/003

(57) ABSTRACT

An electrophotographic photosensitive member is provided. The electrophotographic photosensitive member can output an image having few image defects due to a ghost phenomenon not only under a normal temperature and normal humidity environment but also even under a low temperature and low humidity environment, which is particularly a strict condition. A process cartridge and an electrophotographic apparatus having the electrophotographic photosensitive member are also provided. The electrophotographic photosensitive member has a support and a photosensitive layer formed on the support, wherein the photosensitive layer includes a gallium phthalocyanine crystal including a compound having a structure in which a 7-membered ring and a 5-membered ring are condensed to each other within the crystal.

### BACKGROUND OF THE INVENTION

1. Field of the Invention

The present invention relates to an electrophotographic photosensitive member, a process cartridge and an electrophotographic apparatus having the electrophotographic photosensitive member, and a gallium phthalocyanine crystal.

2. Description of the Related Art

An oscillation wavelength of a semiconductor laser, which has currently been often used as an image exposing unit of electrophotographic photosensitive members, is a long wavelength of 650 to 820 nm. Therefore, development of electrophotographic photosensitive members having high sensitivity to light having such a long wavelength has been advanced.

Phthalocyanine pigments are effective as a charge generating material having high sensitivity to light having a wavelength up to such a long wavelength region. Particularly, oxytitanium phthalocyanines and gallium phthalocyanines have excellent sensitivity characteristics and various crystal forms have ever been reported.

However, there has been a problem in which while electrophotographic photosensitive members using a phthalocyanine pigment have excellent sensitivity characteristics, the generated photocarriers easily remain in the photosensitive layer, thereby readily functioning as a kind of memory to cause potential fluctuations such as a ghost phenomenon.

Japanese Patent Application Laid-Open No. 2001-040237 reports a sensitizing effect is brought about by addition of a specific organic electron acceptor in an acid-pasting process of a phthalocyanine pigment. Problems of the above-described method are, however, concern about a chemical change of the additive (organic electron acceptor) and difficulty in transformation of the crystal form to the desired crystal form.

Then, Japanese Patent Application Laid-Open No. 2006-072304 reports when a pigment and a specific organic electron acceptor are subjected to a wet-pulverization treatment, the organic electron acceptor is incorporated to the crystal surface simultaneously with the crystal transformation, thereby improving electrophotographic characteristics.

In addition, Japanese Patent Application Laid-Open No. H06-161124 discloses that an azulene compound is used in an electrophotographic photosensitive member. As the effect of using the azulene compound, it is demonstrated that the photosensitive member surface is suppressed from being deteriorated and the surface potential of the photosensitive member is suppressed from being reduced.

### SUMMARY OF THE INVENTION

In terms of the further enhancement of the image quality in recent years, however, the image quality deterioration due to the ghost phenomenon has been required to be further improved under various environments. From the results of the studies by the present inventors, the methods described in Japanese Patent Application Laid-Open No. 2006-072304 and Japanese Patent Application Laid-Open No. H06-161124 have been found to be hardly enough in improvement of the image quality deterioration due to the ghost phenomenon in some cases. Specifically, in the method described in Japanese Patent Application Laid-Open No. 2006-072304, the organic electron acceptor is not sufficiently included within the crystal of the obtained phthalocyanine crystal but is just in a state of being mixed with the crystal or just adheres to the surface of the crystal, and therefore there has been still room for improvement in the method. An object of the method described in Japanese Patent Application Laid-Open No. H06-161124 is to suppress deterioration of the photosensitive member surface to suppress reduction in the surface potential of the photosensitive member by making an azulene compound be present on the surface of the photosensitive member. When the azulene compound is just added to the photosensitive member, however, the interaction between the azulene compound and the charge generating material included in the photosensitive member is small, and therefore the azulene compound has been a material which does not affect the electrophotographic characteristics.

The object of the present invention is to provide an electrophotographic photosensitive member capable of outputting an image in which image defects due to the ghost phenomenon are suppressed not only under a normal temperature and normal humidity environment but also even under a low temperature and low humidity environment, which is a strict condition. Further, the objects of the present invention are also to provide a process cartridge and an electrophotographic apparatus having the electrophotographic photosensitive member.

In addition, another object of the present invention is to provide a gallium phthalocyanine crystal which includes a specific compound within the crystal.

The present invention is an electrophotographic photosensitive member having a support and a photosensitive layer formed on the support, wherein the photosensitive layer includes a gallium phthalocyanine crystal including a compound having a structure in which a 7-membered ring and a 5-membered ring are condensed to each other within the crystal.

In addition, the present invention is a process cartridge comprising: the electrophotographic photosensitive member; and at least one unit selected from the group consisting of a charging unit, a developing unit, a transfer unit and a cleaning unit; the electrophotographic photosensitive member and the at least one unit being integrally supported, wherein the process cartridge is detachably mountable to an electrophotographic apparatus main body.

In addition, the present invention is an electrophotographic apparatus having the electrophotographic photosensitive member, and a charging unit, an exposing unit, a developing unit and a transfer unit.

In addition, the present invention is a gallium phthalocyanine crystal including a compound having a structure in which a 7-membered ring and a 5-membered ring are condensed to each other within the crystal.

The present invention can provide an electrophotographic photosensitive member capable of outputting an image having few image defects due to the ghost phenomenon not only under a normal temperature and normal humidity environment but also even under a low temperature and low humidity environment, which is particularly strict condition. In addition, the present invention can provide a process cartridge and an electrophotographic apparatus having the electrophotographic photosensitive member.

Furthermore, the present invention can provide a gallium phthalocyanine crystal having excellent characteristics as a charge generating material.

Further features of the present invention will become apparent from the following description of exemplary embodiments with reference to the attached drawings.

### BRIEF DESCRIPTION OF THE DRAWINGS

FIG. 1 is a drawing illustrating an example of a schematic constitution of an electrophotographic apparatus provided with a process cartridge having an electrophotographic photosensitive member according to the present invention.

FIG. 2 is the powder X-ray diffraction pattern of the hydroxygallium phthalocyanine crystal obtained in Example 1-1.

FIG. 3 is the powder X-ray diffraction pattern of the hydroxygallium phthalocyanine crystal obtained in Example 1-3.

FIG. 4 is the powder X-ray diffraction pattern of the hydroxygallium phthalocyanine crystal obtained in Example 1-4.

FIG. 5A is a drawing illustrating an example of a layer constitution of an embodiment having a single layer type photosensitive layer in an electrophotographic photosensitive member according to the present invention.

FIG. 5B is a drawing illustrating an example of a layer constitution of an embodiment having a laminated type photosensitive layer in an electrophotographic photosensitive member according to the present invention.

### DESCRIPTION OF THE EMBODIMENTS

Preferred embodiments of the present invention will now be described in detail in accordance with the accompanying drawings.

<Electrophotographic Photosensitive Member, Gallium Phthalocyanine Crystal>

The electrophotographic photosensitive member according to the present invention has a support and a photosensitive layer formed on the support, and the photosensitive layer includes a gallium phthalocyanine crystal including a compound having a structure in which a 7-membered ring and a 5-membered ring are condensed to each other within the crystal.

Among the compounds having the structure in which a 7-membered ring and a 5-membered ring are condensed to each other, azulene compounds are preferred, and among the azulene compounds, more preferred compounds are compounds represented by the following formula (1):

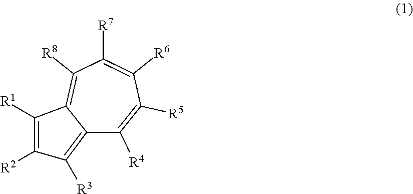

wherein R¹ to R⁸ each independently represent a group selected from the group consisting of a hydrogen atom, an alkyl group, a formyl group, an acetyl group, an alkoxy group, an alkylthio group, an alkoxysulfonyl group, a thiocyano group, a sulfo group, a sodium sulfonate group, a cyano group and a halogen atom.

Particularly, at least one of the R¹ to R⁸ can be a formyl group, a sodium sulfonate group or an alkoxysulfonyl group in the formula (1).

More preferably, the compound represented by the formula (1) is a compound represented by the following formula (2) or a compound represented by the following formula (3):

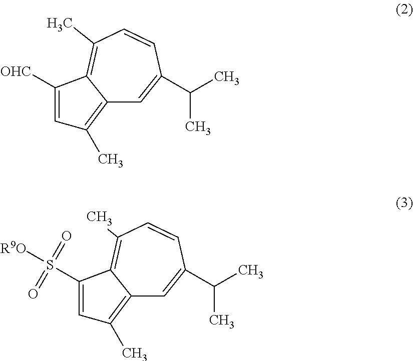

wherein R⁹ is selected from alkyl groups having 1 to 4 carbon atoms.

Preferred specific examples (Exemplified Compounds) of the compounds having the structure in which a 7-membered ring and a 5-membered ring are condensed to each other as described above will be presented below, but the present invention is not limited to these examples.

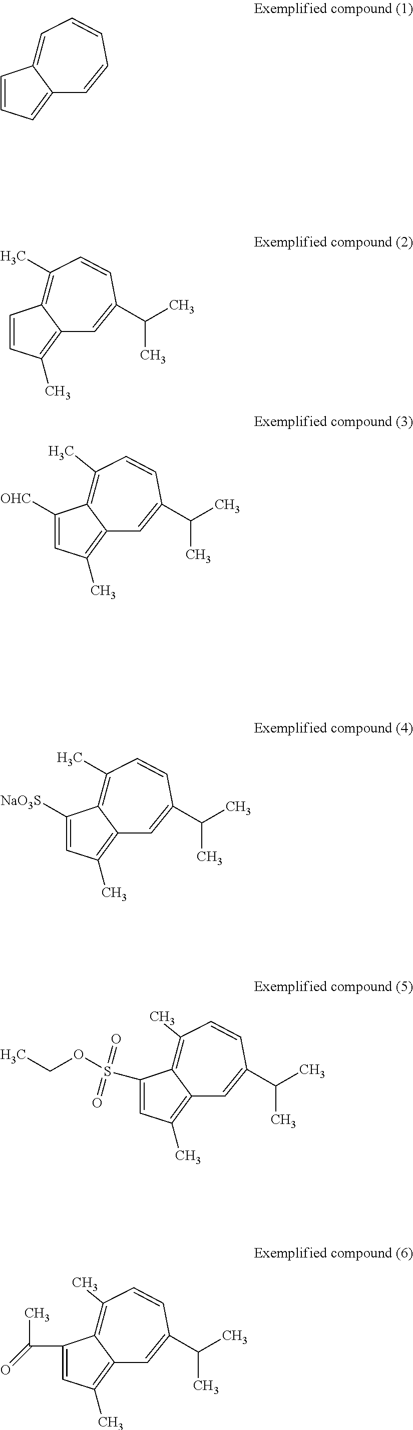

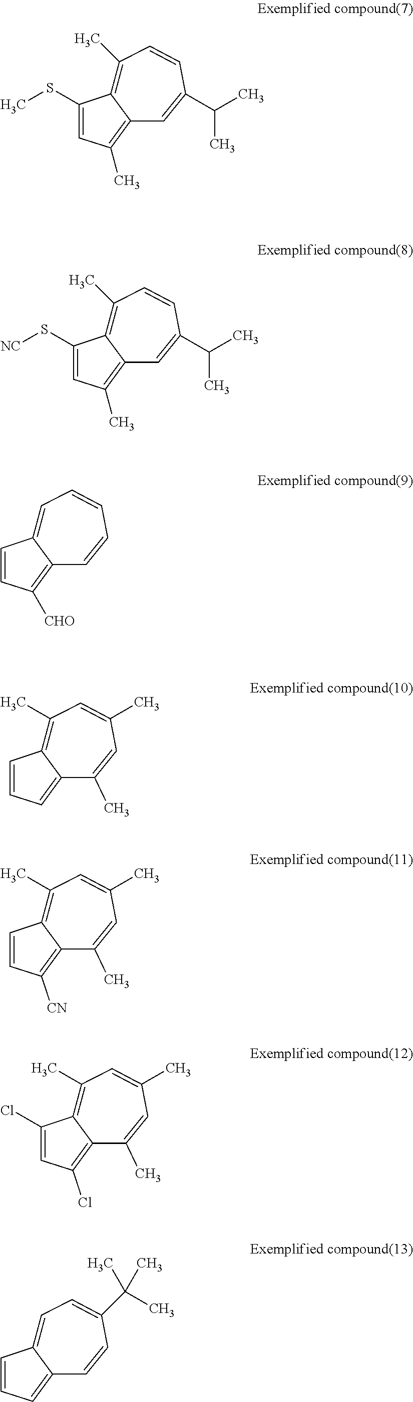

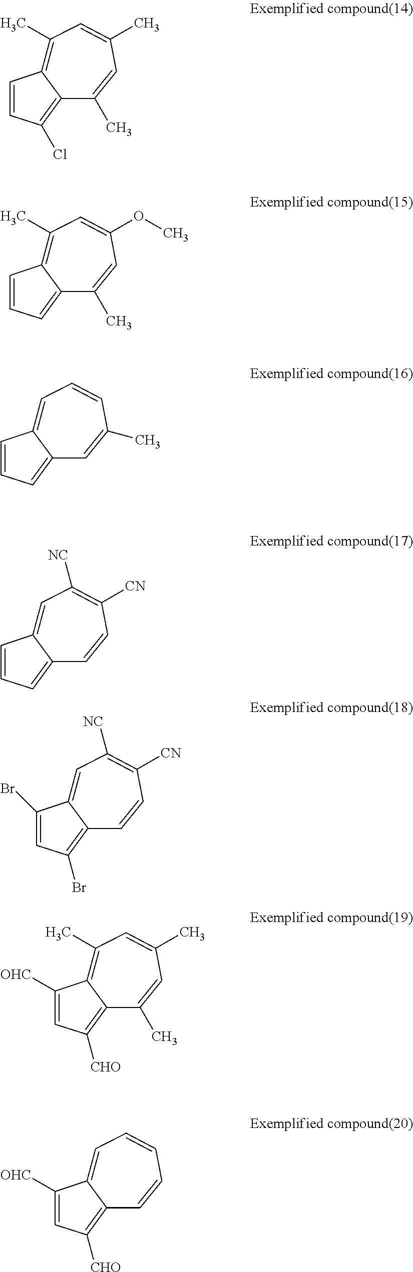

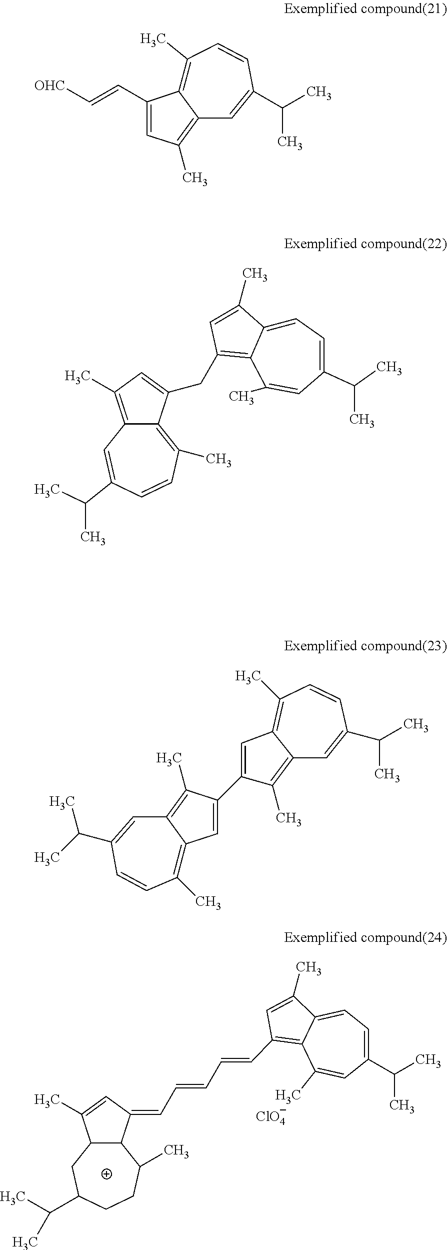

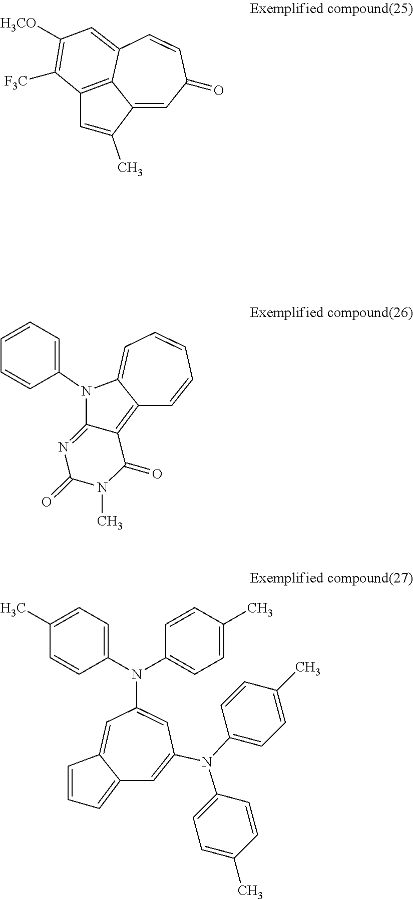

Examples of the gallium phthalocyanine composing the gallium phthalocyanine crystal including the compound having the structure in which a 7-membered ring and a 5-membered ring are condensed to each other within the crystal according to the present invention include gallium phthalocyanines having a halogen atom, a hydroxyl group, or an alkoxy group as an axial ligand to the gallium atom in the gallium phthalocyanine molecule. In addition, the phthalocyanine ring may have a substituent such as a halogen atom.

A gallium phthalocyanine crystal further including N,N-dimethylformamide or/and N-methylformamide within the crystal can be selected.

Among the gallium phthalocyanine crystals, a hydroxygallium phthalocyanine crystal, a chlorogallium phthalocyanine crystal, a bromogallium phthalocyanine crystal, and an iodogallium phthalocyanine crystal, which have excellent sensitivity, is preferred. Among others, the hydroxygallium phthalocyanine crystal is particularly preferred. The hydroxygallium phthalocyanine composing the hydroxygallium phthalocyanine crystal is a gallium phthalocyanine having a hydroxy group as the axial ligand to the gallium atom in the molecule. Chlorogallium phthalocyanine composing the chlorogallium phthalocyanine crystal is a chlorogallium phthalocyanine having a chlorine atom as the axial ligand to the gallium atom in the molecule. Bromogallium phthalocyanine composing the bromogallium phthalocyanine crystal is a bromogallium phthalocyanine having a bromine atom as the axial ligand to the gallium atom in the molecule. Iodogallium phthalocyanine composing the iodogallium phthalocyanine crystal is an iodogallium phthalocyanine having an iodine atom as the axial ligand to the gallium atom in the molecule.

Further, more preferably, the hydroxygallium phthalocyanine crystal is a hydroxygallium phthalocyanine crystal having peaks at Bragg angle 2θ of 7.4°±0.3° and 28.3°±0.3° in X-ray diffraction using CuKα radiation, from the viewpoint of suppression of image defects due to the ghost phenomenon.

The content of the compound having the structure in which a 7-membered ring and a 5-membered ring are condensed to each other included in the gallium phthalocyanine crystal can be 0.01% by mass or more and 3% by mass or less.

A “gallium phthalocyanine crystal including a compound having a structure in which a 7-membered ring and a 5-membered ring are condensed to each other within the crystal” refers to a gallium phthalocyanine crystal incorporating a compound having a structure in which a 7-membered ring and a 5-membered ring are condensed to each other within the crystal.

A method for producing the gallium phthalocyanine crystal including the compound having the structure in which a 7-membered ring and a 5-membered ring are condensed to each other within the crystal will be described. The above-described gallium phthalocyanine crystal may be obtained by, in the process where a gallium phthalocyanine which has been obtained by the acid pasting method is subjected to crystal transformation by mixing the gallium phthalocyanine with a solvent and wet milling-treating the mixture, adding the compound having the structure in which a 7-membered ring and a 5-membered ring are condensed to each other to the above-described mixture and wet milling-treating the resulting mixture without addition of a resin.

The milling treatment performed in the above-described process is for example a treatment in which an object to be milled is milled together with a medium for dispersion, e.g., glass beads, steel beads or alumina balls, using a milling apparatus such as a sand mill or a ball mill. The milling period of time can be approximately from 5 to 100 hours. Particularly, a method in which samples are taken every 5 to 10 hours and the Bragg angles of the crystal are confirmed can be performed. The amount of the medium for dispersion used in the milling treatment can be from 10 to 50 parts by mass based on 1 part by mass of the gallium phthalocyanine. Examples of the solvent include amide solvents such as N,N-dimethylformamide, N,N-dimethylacetamide, N-methylformamide, N-methylacetamide, N-methylpropionamide and N-methyl-2-pyrrolidone; halogen-containing solvents such as chloroform; ether solvents such as tetrahydrofuran, and sulfoxide solvents such as dimethylsulfoxide. The adding amount of the solvent can be from 5 to 30 parts by mass based on 1 part by mass of the gallium phthalocyanine. The adding amount of the compound having the structure in which a 7-membered ring and a 5-membered ring are condensed to each other can be from 0.05 to 2 parts by mass based on 1 part by mass of the gallium phthalocyanine.

In the present invention, it is determined by analyzing data on the NMR measurement and the thermogravimetry (TG) measurement of the obtained gallium phthalocyanine crystal whether the gallium phthalocyanine crystal includes the compound having the structure in which a 7-membered ring and a 5-membered ring are condensed to each other within the crystal or not. Hereinafter, the compound having the structure in which a 7-membered ring and a 5-membered ring are condensed to each other is also referred to as the “specific compound according to the present invention.”

When, for example, the milling treatment is performed using a solvent in which the specific compound according to the present invention is soluble, or the washing process after the milling treatment is performed using a washing solvent in which the specific compound according to the present invention is soluble, the obtained gallium phthalocyanine crystal is measured by NMR. Then, when the specific compound according to the present invention is detected from the obtained gallium phthalocyanine crystal, it can be determined that the specific compound according to the present invention is included within the crystal.

On the other hand, when the specific compound according to the present invention is insoluble in the solvent used in the milling treatment and insoluble also in the solvent used in the washing process after the milling treatment, the obtained gallium phthalocyanine crystal is measured by NMR, and when the specific compound according to the present invention is detected, the determination can be performed by the following method.

TG measurements are separately performed for the gallium phthalocyanine crystal obtained by the milling treatment in which the specific compound according to the present invention is added, the gallium phthalocyanine crystal obtained by the same milling treatment as the milling treatment described above except that the specific compound according to the present invention is not added, and the specific compound according to the present invention alone. First, there may be a case where the TG measurement result for the gallium phthalocyanine crystal obtained in the presence of the specific compound according to the present invention can be construed as just a mixture of the separate measurement result for the gallium phthalocyanine crystal obtained in the absence of the specific compound according to the present invention and the separate measurement result for the specific compound according to the present invention alone at a prescribed ratio. In this case, it can be construed that the gallium phthalocyanine crystal obtained in the presence of the specific compound according to the present invention is a mixture of the gallium phthalocyanine crystal and the specific compound according to the present invention, or the gallium phthalocyanine crystal with the specific compound according to the present invention just attached to the surface of the gallium phthalocyanine crystal.

On the other hand, there may be a case where in the TG measurement result for the gallium phthalocyanine crystal obtained in the presence of the specific compound according to the present invention, an increased weight loss is observed at a temperature higher than the temperature at which the weight loss is completed in the TG measurement result for the specific compound according to the present invention alone compared with the TG measurement result for the gallium phthalocyanine crystal obtained in the absence of the specific compound according to the present invention. In this case, it can be determined that the gallium phthalocyanine crystal obtained in the presence the specific compound according to the present invention includes the specific compound according to the present invention within the crystal.

The TG measurement, X-ray diffraction measurement and NMR measurement of the gallium phthalocyanine crystals according to the present invention were performed under the following conditions.

[TG Measurement]

Instrument used: a TG/DTA simultaneous measuring instrument, TG/DTA220U (trade name, manufactured by Seiko Instruments Inc.)
Atmosphere: under nitrogen stream (300 cm³/min)
Measuring temperature range: from 35° C. to 600° C.
Temperature raising rate: 10° C./min

[Powder X-Ray Diffraction Measurement]

Instrument used: an X-ray diffraction instrument, RINT-TTRII (trade name, manufactured by Rigaku Corporation)
X-ray tube: Cu
Tube voltage: 50 kV
Tube current: 300 mA
Scanning method: 2θ/θ scanning
Scanning rate: 4.0°/min
Sampling interval: 0.02°
Starting angle (2θ): 5.0°
Stopping angle (2θ): 40.0°
Attachment: standard sample holder
Filter: not used
Incident beam monochromator: used
Counter monochromator: not used
Divergence slit: open
Vertical divergence limiting slit: 10.00 mm
Scattering slit: open
Receiving slit: open
Flat monochromator: used
Counter: scintillation counter

[NMR Measurement]

Instrument used: AVANCEIII 500 (trade name, manufactured by Bruker Corporation)
Solvent: deuterated sulfuric acid (D₂SO₄)

The gallium phthalocyanine crystal including the compound having the structure in which a 7-membered ring and a 5-membered ring are condensed to each other within the crystal is excellent in functions as a photoconductor and applicable for solar cells, sensors, switching elements and the like besides the electrophotographic photosensitive member.

Then, cases using the gallium phthalocyanine crystal including the compound having the structure in which a 7-membered ring and a 5-membered ring are condensed to each other within the crystal as a charge generating material in an electrophotographic photosensitive member will be described.

The electrophotographic photosensitive member according to the present invention has a support and a photosensitive layer formed on the support. The photosensitive layer includes a single layer type photosensitive layer including both a charge generating material and a charge transporting material, and a laminated type photosensitive layer having a charge generating layer including the charge generating material and a charge transporting layer including the charge transporting material, separately. Among the photosensitive layers described above, the laminated type photosensitive layer having the charge generating layer and the charge transporting layer formed on the charge generating layer can be selected.

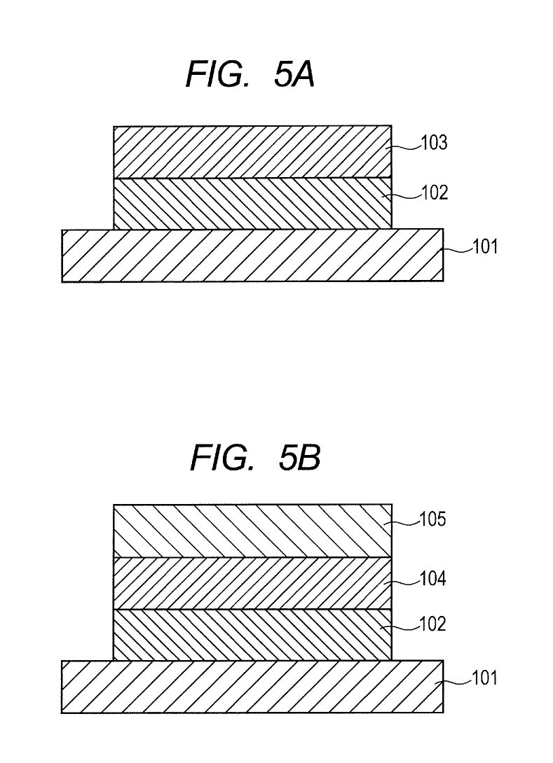

Each of FIG. 5A and FIG. 5B is a drawing illustrating an example of the layer constitution of the electrophotographic photosensitive member of the present invention. FIG. 5A illustrates a case of the single layer type photosensitive layer where an undercoat layer 102 and a photosensitive layer 103 are formed on a support 101. FIG. 5B illustrates a case of the laminated layer type photosensitive layer where the undercoat layer 102, a charge generating layer 104 and a charge transporting layer 105 are formed on the support 101.

(Support)

The support can be a support having conductivity (conductive support). Examples of the support include supports made of metals and alloys such as aluminum, aluminum alloys, copper, zinc, stainless steel, vanadium, molybdenum, chromium, titanium, nickel, indium, gold and platinum. In addition, there may be used supports made of resins having a layer which is formed of aluminum, aluminum alloys, indium oxide, tin oxide and indium oxide-tin oxide alloys by means of film-formation through the vacuum deposition technique. Further, there may be used as the support: plastic or paper impregnated with a conductive particle and plastic containing a conductive polymer. The surface of the support may be subjected to cutting treatment, roughening treatment, alumite treatment, electrochemical buffing treatment, wet honing treatment, dry honing treatment or the like for the purpose of suppressing interference fringes due to the laser beam scattering.

A conductive layer may be provided between the support and an undercoat layer described below for the purpose of suppressing interference fringes due to the laser beam scattering, masking (covering) flaws on the support or the like. The conductive layer may be formed by applying an application liquid for the conductive layer obtained by dispersing-treating a conductive particle such as carbon black, a metal particle or a metal oxide particle, and a binder resin and a solvent to form a coating film, and drying the resulting coating film.

Examples of the conductive particle include an aluminum particle, a titanium oxide particle, a tin oxide particle, a zinc oxide particle, carbon black and a silver particle. Examples of the binder resin include polyesters, polycarbonates, polyvinyl butyral, acrylic resins, silicone resins, epoxy resins, melamine resins, urethane resins, phenol resins and alkyd resins. Examples of the solvent for the application liquid for the conductive layer include ether solvents, alcoholic solvents, ketone solvents and aromatic hydrocarbon solvents.

Furthermore, an undercoat layer may be provided between the support and the photosensitive layer. The undercoat layer (also referred to as barrier layer or intermediate layer) has a barrier function and an adhesive function. The undercoat layer may be formed by applying an application liquid for the undercoat layer obtained by mixing a binder resin and a solvent to form a coating film and drying the resulting coating film.

Examples of the binder resin include polyvinyl alcohol, polyethylene oxide, ethyl cellulose, methyl cellulose, casein, polyamides (nylon 6, nylon 66, nylon 610, copolymer nylons, N-alkoxymethylated nylons and the like), polyurethanes, acrylic resins, allyl resins, alkyd resins and epoxy resins. The film thickness of the undercoat layer is preferably from 0.1 to 10 μm, and more preferably from 0.5 to 5 μm. Examples of the solvent for the application liquid for the undercoat layer include ether solvents, alcoholic solvents, ketone solvents and aromatic hydrocarbon solvents.

(Photosensitive Layer)

When the single layer type photosensitive layer is formed, an application liquid for the single layer type photosensitive layer is prepared by mixing the gallium phthalocyanine crystal including the compound having the structure in which a 7-membered ring and a 5-membered ring are condensed to each other within the crystal as a charge generating material, a charge transporting material and a binder resin in a solvent. The single layer type photosensitive layer may be formed by applying the application liquid to form a coating film and drying the resulting coating film.

When the laminated layer type photosensitive layer is formed, an application liquid for the charge generating layer is prepared by mixing the gallium phthalocyanine crystal including the compound having the structure in which a 7-membered ring and a 5-membered ring are condensed to each other within the crystal as the charge generating material and a binder resin in a solvent. The charge generating layer may be formed by applying the application liquid for the charge generating layer to form a coating film and drying the resulting coating film. In addition, the charge generating layer may be formed by vapor deposition.

Examples of the binder resin used in the single layer type photosensitive layer or the charge generating layer include polycarbonates, polyesters, butyral resins, polyvinyl acetal, acrylic resins, vinyl acetate resins and urea resins. Among the resins described above, butyral resin can be selected. In addition, the binder resins described above may be used singly or in combinations of two or more as a mixture or a copolymer.

Examples of the solvent used in the application liquid for the single layer type photosensitive layer or the application liquid for the charge generating layer include alcoholic solvents, sulfoxide solvents, ketone solvents, ether solvents, ester solvents and aromatic hydrocarbon solvents. In addition, the solvents described above may be used singly or in combinations of two or more.

When the photosensitive layer is the single layer type (single layer type photosensitive layer), the content of the charge generating material can be from 3 to 30% by mass based on the total mass of the photosensitive layer. In addition, the content of the charge transporting material can be from 30 to 70% by mass based on the total mass of the photosensitive layer. The film thickness of the single layer type photosensitive layer is preferably from 5 to 40 μm, and more preferably from 10 to 30 μm.

When the photosensitive layer is the laminated type (laminated type photosensitive layer), the content of the charge generating material is preferably from 20 to 90% by mass, and more preferably from 50 to 80% by mass based on the total mass of the charge generating layer. The film thickness of the charge generating layer is preferably from 0.01 to 10 μm, and more preferably from 0.1 to 3 μm.

In the present invention, the gallium phthalocyanine crystal including the compound having the structure in which a 7-membered ring and a 5-membered ring are condensed to each other within the crystal is used as the charge generating material, and the gallium phthalocyanine crystal can be used in a mixture with another charge generating material. In this case, the content of the gallium phthalocyanine crystal including the compound having the structure in which a 7-membered ring and a 5-membered ring are condensed to each other within the crystal can be 50% or more by mass based on the total mass of the charge generating materials.

(Charge Transporting Layer)

The charge transporting layer may be formed by applying an application liquid for the charge transporting layer obtained by dissolving a charge transporting material and a binder resin in a solvent to form a coating film and drying the resulting coating film.

Examples of the charge transporting material include triarylamine compounds, hydrazone compounds, stilbene compounds, pyrazoline compounds, oxazole compounds, thiazole compounds and triallylmethane compounds.

Examples of the binder resin used in the charge transporting layer include resins such as polyesters, acrylic resins, polyvinylcarbazole, phenoxy resins, polycarbonates, polyvinyl butyral, polystyrene, polyvinyl acetate, polysulfone, polyarylates, polyvinylidene chloride, acrylonitrile copolymers and polyvinyl benzal.

The content of the charge transporting material is preferably from 20 to 80% by mass, and more preferably from 30 to 70% by mass based on the total mass of the charge transporting layer. The film thickness of the charge transporting layer is preferably from 5 to 40 μm, and more preferably from 10 to 30 μm.

The photosensitive layer may be applied by employing an applying technique such as the dipping technique, the spray coating technique, the spin coating technique, the bead coating technique, the blade coating technique or the beam coating technique.

(Protective Layer)

A protective layer may be provided on the photosensitive layer as necessary. The protective layer may be formed by applying an application liquid for the protective layer obtained by dissolving a binder resin in a solvent to form a coating film and drying the resulting coating film. Examples of the binder resin include polyvinyl butyral, polyesters, polycarbonates (polycarbonate Z, modified polycarbonates and the like), nylons, polyimides, polyarylates, polyurethanes, styrene-butadiene copolymers, styrene-acrylic acid copolymers and styrene-acrylonitrile copolymers.

In addition, the protective layer with charge transporting ability may be formed by curing a monomer having charge transporting ability (positive hole transporting ability) through various polymerization reactions and crosslinking reactions. Specifically, the protective layer can be formed by polymerizing or crosslinking a charge transporting compound (positive hole transporting compound) having a chain-polymerizable functional group to cure the resulting compound.

The film thickness of the protective layer can be from 0.05 to 20 μm. A conductive particle, an ultraviolet absorber or the like may be included in the protective layer. Examples of the conductive particle include metal oxide particles such as tin oxide particles.

<Electrophotographic Apparatus, Process Cartridge>

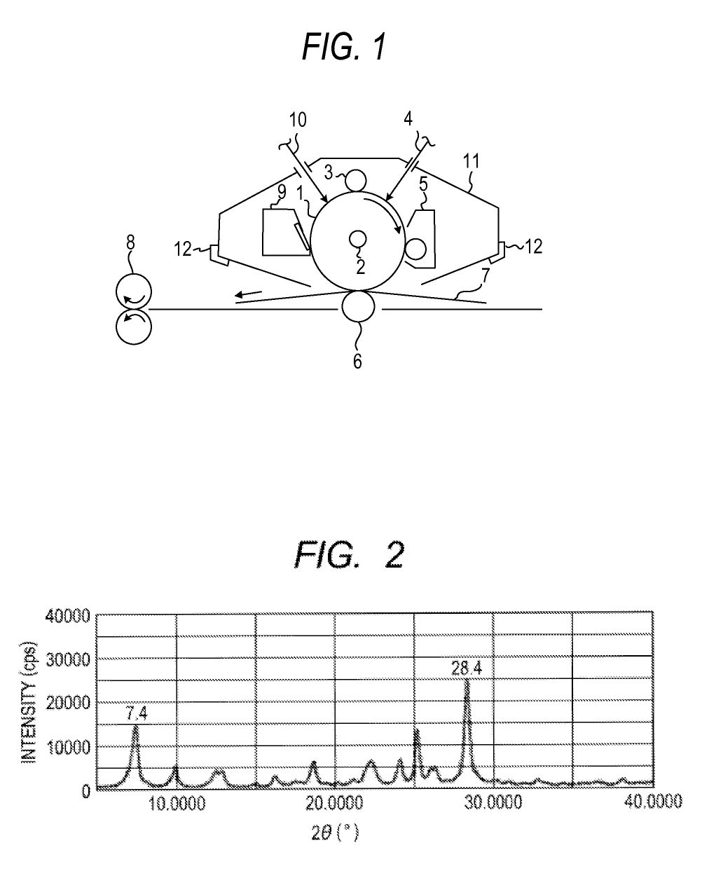

FIG. 1 illustrates an example of a schematic constitution of an electrophotographic apparatus provided with a process cartridge having the electrophotographic photosensitive member.

In FIG. 1, a cylindrical (drum-like) electrophotographic photosensitive member 1 is rotationally driven around an axis 2 in the direction of the arrow at a prescribed peripheral velocity (process speed). The surface of the electrophotographic photosensitive member 1 is charged to a prescribed positive or negative potential by a charging unit 3 during the rotation step. Subsequently, the charged surface of the electrophotographic photosensitive member 1 is irradiated with exposure light 4 from an exposing unit (not shown), whereby an electrostatic latent image corresponding to an objective image information is being formed. The exposure light 4 is light which is output from an exposing unit such as slit exposure or laser beam scanning exposure and intensity-modulated depending on the time-series electric digital image signal of the objective image information.

The electrostatic latent image formed on the surface of the electrophotographic photosensitive member 1 is developed (normal development or reversal development) with a developing agent (toner) placed in a developing unit 5 and a toner image is formed on the surface of the electrophotographic photosensitive member 1. The toner image formed on the surface of the electrophotographic photosensitive member 1 is being transferred to a transfer material 7 by a transfer unit 6. At this time, a voltage with a reverse polarity to the polarity of the retained charge on the toner (transfer bias) is applied to the transfer unit 6 from a bias power supply (not shown). In addition, the transfer material 7 is taken out from a transfer material supplying unit (not shown) in synchronization with the rotation of the electrophotographic photosensitive member 1 and fed between the electrophotographic photosensitive member 1 and the transfer unit 6 (contact part).

The transfer material 7 to which the toner image has been transferred is separated from the surface of the electrophotographic photosensitive member 1, delivered to a fixing unit 8 to be subjected to fixing treatment of the toner image, and printed out of the electrophotographic apparatus as an image-formed material (print, copy).

The surface of the electrophotographic photosensitive member 1 from which the toner image has been transferred to the transfer material 7 is subjected to removal of the deposits such as the remaining developing agent after transfer (toner left after transfer) by a cleaning unit 9 to be cleaned. In addition, the toner left after transfer may be recovered by the developing unit or the like (cleaner-less system). Furthermore, the surface of the electrophotographic photosensitive member 1 is irradiated with pre-exposure light 10 from a pre-exposing unit (not shown) to be discharging-processed, followed by being repeatedly used in forming images. When the charging unit 3 is a contact charging unit using a charging roller or the like as illustrated in FIG. 1, the pre-exposing unit is not necessarily required.

In the present invention, a plurality of constituents among the constituents described above such as the electrophotographic photosensitive member 1, the charging unit 3, the developing unit 5 and the cleaning unit 9 may be placed in a container to be integrally supported, thereby forming a process cartridge. The process cartridge may be constituted to be detachably mountable to the electrophotographic apparatus main body. For example, the electrophotographic photosensitive member 1 and at least one selected from the charging unit 3, the developing unit 5, the transfer unit 6 and the cleaning unit 9 are integrally supported to form the cartridge. Then, the process cartridge 11 can be made detachably mountable to the electrophotographic apparatus main body by using a guiding unit 12 such as rails in the electrophotographic apparatus main body.

When the electrophotographic apparatus is a copying machine, the exposure light 4 may be reflecting light or transmitted light from the manuscript. Alternatively, the exposure light 4 may be light emitted in scanning a laser beam, driving a LED array or driving a liquid crystal shutter array operated according to the signals into which the manuscript read by a sensor is converted.

### EXAMPLES

Hereinafter, the present invention will be described in more detail proving specific Examples. The present invention, however, is not limited to these examples. As used hereinafter, the term “part(s)” refers to “part(s) by mass.” The film thickness of each layer of the electrophotographic photosensitive member of Examples and Comparative Examples was measured using an eddy-current type film thickness meter, Fischerscope (trade name, available from Fischer Instruments K.K.) or was determined from the mass per unit area thereof by specific gravity conversion.

### Example 1-1

In the same manner as the manner described in (Synthesis Example 1) and the following (Example 1-1) in Japanese Patent Application Laid-Open No. 2011-094101, hydroxygallium phthalocyanine was prepared as described below. In a reaction vessel, 5.46 parts of phthalonitrile and 45 parts of α-chloronaphthalene were introduced under a nitrogen flow atmosphere, heated so as to raise the temperature to 30° C., and then kept at the temperature. Subsequently, 3.75 parts of gallium trichloride was introduced to the mixture at the above temperature (30° C.) The water content of the liquid mixture was 150 ppm at the time of adding gallium trichloride. The temperature was then raised to 200° C. After the mixture was reacted for 4.5 hours at a temperature of 200° C. under a nitrogen flow atmosphere, the mixture was cooled, and the products were filtered when the temperature reached 150° C. The resulting filtered solid was washed with N,N-dimethylformamide in a dispersion state at a temperature of 140° C. for 2 hours, followed by filtering. The resulting filtered solid was washed with methanol and then dried to give 4.65 parts of chlorogallium phthalocyanine pigment (71% yield). Subsequently, 4.65 parts of the chlorogallium phthalocyanine pigment thus obtained was dissolved in 139.5 parts of concentrated sulfuric acid at a temperature of 10° C., the resulting solution was dropped into 620 parts of ice water under stirring for re-precipitation, and then the precipitate was filtered using a filter press. The resulting wet cake (filtered solid) was washed with 2% ammonia water in a dispersion state, followed by filtering using a filter press. The resulting wet cake (filtered solid) was then washed with ion exchange water in a dispersion state, followed by filtering using a filter press, and the washing and filtering were repeated three times to give a hydroxygallium phthalocyanine with a solid content of 23% (water-containing hydroxygallium phthalocyanine). The hydroxygallium phthalocyanine (water-containing hydroxygallium phthalocyanine) thus obtained (6.6 kg) was dried under microwave irradiation using a drier, HYPER-DRY HD-06R (trade name, frequency (oscillation frequency) of 2455 MHz±15 MHz, available from Biocon (Japan) Ltd.).

Together with 15 parts of glass beads having a diameter of 0.8 mm, 0.5 part of above-described hydroxygallium phthalocyanine, 0.5 part of Exemplified Compound (1) (manufactured by Konan Chemical Industry Co., Ltd.), and 9.5 parts of N,N-dimethylformamide were milling-treated using a ball mill at room temperature (23° C.) for 50 hours. A hydroxygallium phthalocyanine crystal was taken out of the dispersion with N,N-dimethylformamide and filtered, and the residue on the filter was sufficiently washed with N,N-dimethylformamide, and then sufficiently washed with tetrahydrofuran. The filtered solid was vacuum dried to give 0.47 part of a hydroxygallium phthalocyanine crystal. FIG. 2 illustrates the powder X-ray diffraction pattern of the resulting crystal.

In the hydroxygallium phthalocyanine crystal, 0.63% by mass of Exemplified Compound (1) and 1.74% by mass of N,N-dimethylformamide were confirmed to be included through the conversion based on the proton ratio in the NMR measurement. Since Exemplified Compound (1), though solid, is soluble in N,N-dimethylformamide, Exemplified Compound (1) is found to be included within the hydroxygallium phthalocyanine crystal.

### Example 1-2

A hydroxygallium phthalocyanine crystal (0.49 part) was obtained by the same processing as the processing in Example 1-1 except that 0.5 part of Exemplified Compound (1) in Example 1-1 was changed to 0.5 part of Exemplified Compound (2). The powder X-ray diffraction pattern of the resulting crystal was similar to the powder X-ray diffraction pattern illustrated in FIG. 2.

In the hydroxygallium phthalocyanine crystal, 0.22% by mass of Exemplified Compound (2) and 1.78% by mass of N,N-dimethylformamide were confirmed to be included through the conversion based on the proton ratio in the NMR measurement. Since Exemplified Compound (2), though solid, is soluble in N,N-dimethylformamide, Exemplified Compound (2) is found to be included within the hydroxygallium phthalocyanine crystal.

### Example 1-3

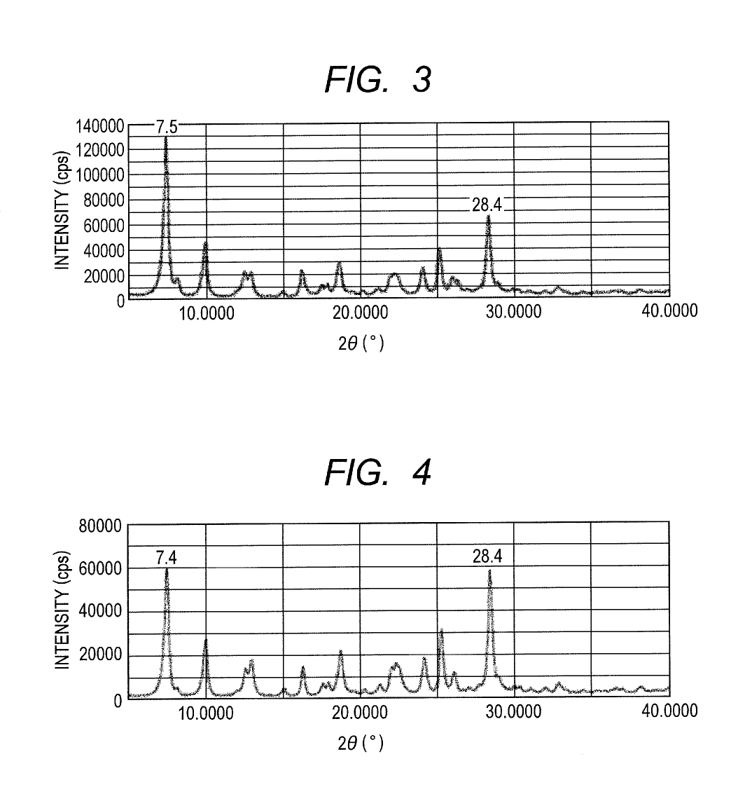

A hydroxygallium phthalocyanine crystal (0.44 part) was obtained by the same processing as the processing in Example 1-1 except that 0.5 part of Exemplified Compound (1) in Example 1-1 was changed to 0.5 part of Exemplified Compound (3). FIG. 3 illustrates the powder X-ray diffraction pattern of the resulting crystal.

In the hydroxygallium phthalocyanine crystal, 0.38% by mass of Exemplified Compound (3) and 1.87% by mass of N,N-dimethylformamide were confirmed to be included through the conversion based on the proton ratio in the NMR measurement. Since Exemplified Compound (3), though solid, is soluble in N,N-dimethylformamide, Exemplified Compound (3) is found to be included within the hydroxygallium phthalocyanine crystal.

### Example 1-4

A hydroxygallium phthalocyanine crystal (0.41 part) was obtained by the same processing as the processing in Example 1-1 except that 0.5 part of Exemplified Compound (1) in Example 1-1 was changed to 0.5 part of Exemplified Compound (4). FIG. 4 illustrates the powder X-ray diffraction pattern of the resulting crystal.

In the hydroxygallium phthalocyanine crystal, 0.16% by mass of Exemplified Compound (4) and 1.43% by mass of N,N-dimethylformamide were confirmed to be included through the conversion based on the proton ratio in the NMR measurement. Since Exemplified Compound (4), though solid, is soluble in N,N-dimethylformamide, Exemplified Compound (4) is found to be included within the hydroxygallium phthalocyanine crystal.

### Example 1-5

A hydroxygallium phthalocyanine crystal (0.47 part) was obtained by the same processing as the processing in Example 1-1 except that 0.5 part of Exemplified Compound (1) in Example 1-1 was changed to 0.5 part of Exemplified Compound (5). The powder X-ray diffraction pattern of the resulting crystal was similar to the powder X-ray diffraction pattern illustrated in FIG. 3.

In the hydroxygallium phthalocyanine crystal, 0.10% by mass of Exemplified Compound (5) and 2.03% by mass of N,N-dimethylformamide were confirmed to be included through the conversion based on the proton ratio in the NMR measurement. Since Exemplified Compound (5), though solid, is soluble in N,N-dimethylformamide, Exemplified Compound (5) is found to be included within the hydroxygallium phthalocyanine crystal.

### Example 1-6

A hydroxygallium phthalocyanine crystal (0.42 part) was obtained by the same processing as the processing in Example 1-3 except that N,N-dimethylformamide and the milling treatment time of 50 hours in Example 1-3 were changed to N-methylformamide and the milling treatment time of 72 hours, respectively. The powder X-ray diffraction pattern of the resulting crystal was similar to the powder X-ray diffraction pattern illustrated in FIG. 4.

In the hydroxygallium phthalocyanine crystal, 0.20% by mass of Exemplified Compound (3) and 1.39% by mass of N-methylformamide were confirmed to be included through the conversion based on the proton ratio in the NMR measurement. Since Exemplified Compound (3), though solid, is soluble in N-methylformamide, Exemplified Compound (3) is found to be included within the hydroxygallium phthalocyanine crystal.

### Example 1-7

A hydroxygallium phthalocyanine crystal (0.42 part) was obtained by the same processing as the processing in Example 1-6 except that 0.5 part of Exemplified Compound (3) in Example 1-6 was changed to 0.5 part of Exemplified Compound (5). The powder X-ray diffraction pattern of the resulting crystal was similar to the powder X-ray diffraction pattern illustrated in FIG. 4.

In the hydroxygallium phthalocyanine crystal, 0.66% by mass of Exemplified Compound (5) and 1.46% by mass of N-methylformamide were confirmed to be included through the conversion based on the proton ratio in the NMR measurement. Since Exemplified Compound (5), though solid, is soluble in N-methylformamide, Exemplified Compound (5) is found to be included within the hydroxygallium phthalocyanine crystal.

### Comparative Example 1-1

A hydroxygallium phthalocyanine crystal (0.44 part) was obtained by the same processing as the processing in Example 1-1 except that 0.5 part of Exemplified Compound (1) in Example 1-1 was not added. The powder X-ray diffraction pattern of the resulting crystal was similar to the powder X-ray diffraction pattern illustrated in FIG. 3.

### Example 2-1

An application liquid for the conductive layer was prepared by introducing 60 parts of a barium sulfate particle covered with tin oxide, Passtran PC1 (trade name, manufactured by Mitsui Mining & Smelting Co., Ltd.), 15 parts of a titanium oxide particle, TITANIX JR (trade name, manufactured by Tayca Corporation), 43 parts of a resol-type phenol resin, Phenolite J-325 (trade name, manufactured by DIC Corporation, solid content of 70% by mass), 0.015 part of silicone oil, SH28PA (trade name, manufactured by Dow Corning Toray Co., Ltd.), 3.6 parts of silicone resin, Tospearl 120 (trade name, manufactured by Momentive Performance Materials Japan LLC), 50 parts of 2-methoxy-1-propanol, and 50 parts of methanol in a ball mill and dispersing-treating the mixture for 20 hours.

The application liquid for the conductive layer thus obtained was dip-coated on an aluminum cylinder (diameter of 24 mm) as a support to form a coating film and the resulting coating film was dried at 140° C. for 30 minutes. A conductive layer having a film thickness of 15 μm was formed in this manner.

Then, 10 parts of a copolymer nylon resin, Amilan CM8000 (trade name, manufactured by Toray Industries, Inc.), and 30 parts of a methoxymethylated 6 nylon resin, Toresin EF-30T (trade name, manufactured by Nagase ChemteX Corporation) were dissolved in a mixed solvent of 400 parts of methanol/200 parts of n-butanol to prepare an application liquid for the undercoat layer.

The application liquid for the undercoat layer thus obtained was dip-coated on the conductive layer described above to form a coating film and the resulting coating film was dried to form an undercoat layer having a film thickness of 0.5 μm.

Then, mixing was carried out using the following materials, namely, 10 parts of the hydroxygallium phthalocyanine crystal (charge generating material) obtained in Example 1-1, 5 parts of polyvinyl butyral, S-LEC BX-1 (trade name, manufactured by Sekisui Chemical Co., Ltd.), and 250 parts of cyclohexanone. The resulting mixture was introduced into a sand mill using glass beads having a diameter of 1 mm, and dispersing-treated for 4 hours to prepare a dispersion. Then, 250 parts of ethyl acetate was added to the dispersion for dilution to prepare an application liquid for the charge generating layer. The application liquid for the charge generating layer thus obtained was dip-coated on the undercoat layer described above to form a coating film, and the resulting coating film was dried at 100° C. for 10 minutes to form a charge generating layer having a film thickness of 0.16 μm.

Then, an application liquid for the charge transporting layer was prepared by dissolving 7 parts of a compound (charge transporting material) represented by the following formula (4), 1 part of a compound (charge transporting material) represented by the following formula (5), and 10 parts of a polycarbonate, Iupilon Z-200 (trade name, manufactured by Mitsubishi Gas Chemical Company, Inc.) in 70 parts of monochlorobenzene:

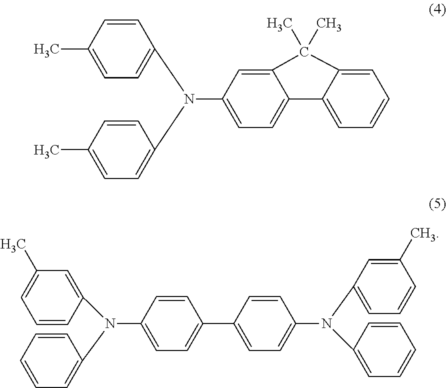 [SMILES: Cc1ccc(N(c2ccc(C)cc2)c2ccc3c(c2)C(C)(C)c2ccccc2-3)cc1 ; Cc1cccc(N(c2ccccc2)c2ccc(-c3ccc(N(c4ccccc4)c4cccc(C)c4)cc3)cc2)c1]

The application liquid for the charge transporting layer thus obtained was dip-coated on the charge generating layer described above to form a coating film, and the resulting coating film was dried at 110° C. for 1 hour to form a charge transporting layer having a film thickness of 23 μm.

A cylindrical (drum-like) electrophotographic photosensitive member of Example 2-1 was manufactured in this way.

### Examples 2-2 to 2-7

The material was changed from the hydroxygallium phthalocyanine crystal used in the preparation of the application liquid for the charge generating layer in Example 2-1 to the hydroxygallium phthalocyanine crystals obtained in Examples 1-2 to 1-7, respectively. Each of electrophotographic photosensitive members of Examples 2-2 to 2-7 was manufactured in the same manner as the manner in Example 2-1 except for the change described above.

### Comparative Example 2-1

The material was changed from the hydroxygallium phthalocyanine crystal used in the preparation of the application liquid for the charge generating layer in Example 2-1 to the hydroxygallium phthalocyanine crystal obtained in Comparative Example 1-1. An electrophotographic photosensitive member of Comparative Example 2-1 was manufactured in the same manner as the manner in Example 2-1 except for the change described above.

### Comparative Example 2-2

An electrophotographic photosensitive member of Comparative Example 2-2 was manufactured in the same manner as the manner in Comparative Example 2-1 except that 0.1 part of Exemplified Compound (1) was added based on 10 parts of the hydroxygallium phthalocyanine crystal obtained in Comparative Example 1-1 in the preparation of the application liquid for the charge generating layer in Comparative Example 2-1.

(Evaluation of Examples 2-1 to 2-7 and Comparative Examples 2-1 to 2-2)

Evaluation of the ghost image was performed for the electrophotographic photosensitive members of Examples 2-1 to 2-7 and Comparative Examples 2-1 to 2-2.

As the electrophotographic apparatus for use in the evaluation, a laser beam printer, Color Laser Jet CP3525dn (trade name, manufactured by Hewlett-Packard Japan, Ltd.) was remodeled as described below, and then used. That is, the printer was remodeled so that the pre-exposure light was not emitted and the printer operated with variable charging conditions and a variable image exposure amount. In addition, each manufactured electrophotographic photosensitive member was mounted on the process cartridge for a cyan color and the cartridge was mounted on the station for the cyan color cartridge, and the printer was remodeled so that the printer operated without the process cartridges for other colors mounted on the printer main body.

When the images were output, only the process cartridge for the cyan color was mounted on the main body and monochromatic images with a cyan toner only were output.

First, under a normal temperature and normal humidity environment of a temperature of 23° C./humidity of 55% RH, the charging conditions and the image exposure amount were adjusted so that the initial dark part potential was −500 V and the initial bright part potential was −100 V. For the surface potential of each cylindrical electrophotographic photosensitive member upon the potential setting, measurement was carried out using a cartridge remodeled so as to be mounted a potential prove, model 6000B-8 (trade name, manufactured by Trek Japan K.K.) at the developing position. In addition, a potential was measured at the central position of each cylindrical electrophotographic photosensitive member using a surface electrometer, model 344 (trade name, manufactured by Trek Japan K.K.).

Then, ghost image evaluation was performed under the same conditions. Subsequently, a repeating paper-feeding test was carried out with 1,000 sheets of paper, and the ghost image evaluation was performed immediately after the repeating paper-feeding test and after 15 hours of the repeating paper-feeding test. Table 1 presents the results of the evaluation under the normal temperature and normal humidity environment.

Then, after leaving each electrophotographic photosensitive member together with the electrophotographic apparatus for use in the evaluation to stand under a low temperature and low humidity environment of a temperature of 15° C./humidity of 10% RH for 3 days, the ghost image evaluation was performed. Further, the repeating paper-feeding test was carried out with 1,000 sheets of paper under the same conditions, and the ghost image evaluation was performed immediately after the repeating paper-feeding test and after 15 hours of the repeating paper-feeding test. Table 1 additionally presents the results of the evaluation under the low temperature and low humidity environment.

The repeating paper-feeding test was carried out under conditions where letter E images were printed with a cyan toner monochrome on plain paper sheets of A4 size at a printing rate of 1%.

The ghost image evaluation was performed through the procedures described below. In the ghost image evaluation, a solid white image was output on the first sheet, followed by outputting 4 kinds of ghost charts with 1 sheet for each kind, i.e., 4 sheets in total. Then, a solid black image was output on 1 sheet, followed by again outputting 4 kinds of ghost charts with 1 sheet for each kind, i.e., 4 sheets in total. The image output was carried out in this order, and the evaluation was performed with 8 sheets of the ghost images. In each ghost chart, four solid black squares with 25 mm per side were arranged in parallel at equal intervals on a solid white background in the range from the writing start position of the output image (10 mm from the upper edge of the sheet) to the position at 30 mm from the writing start position, and 4 kinds of halftone printing patterns were output in the range below the position at 30 mm from the writing start position of the output image. Then, ranking was performed based on the 4 kinds of ghost charts.

The 4 kinds of ghost charts refer to the charts in which only the halftone patterns in the range below the position at 30 mm from the writing start position of the output image are different from each other and the halftone patterns are the following 4 kinds.

(1) A printing (laser exposure) pattern of 1 dot and 1 space in transverse direction*. *: transverse direction refers to the scanning direction of the laser scanner (horizontal direction in the output sheets).
(2) A printing (laser exposure) pattern of 2 dot and 2 space in transverse direction*.
(3) A printing (laser exposure) pattern of 2 dot and 3 space in transverse direction*.
(4) A printing (laser exposure) pattern of a pattern of knight of chess (a pattern in which 2 dots are printed per 6 squares on a grid, like a move of knight of chess).

The ranking of the ghost images was performed by visual observation as described below. Ranks 4, 5 and 6 were rated as the levels where the effects of the present invention were not obtained sufficiently.

Rank 1: no ghosts are observed in any ghost chart.
Rank 2: a ghost is slightly observed in a specific ghost chart.
Rank 3: a ghost is slightly observed in any ghost chart.
Rank 4: a ghost is observed in a specific ghost chart.
Rank 5: a ghost is observed in any ghost chart.
Rank 6: a ghost is clearly observed in a specific ghost chart.

TABLE 1

| | Ghost rank | | | | | |
|---|---|---|---|---|---|---|
| | Under normal temperature | | | Under low temperature | | |
| | and normal humidity | | | and low humidity | | |
| | environment | | | environment | | |
| | | Imme- | | | Imme- | |
| | | diately | After 15 | | diately | After 15 |
| | | after | hours of | | after | hours of |
| | | repeat- | repeat- | | repeat- | repeat- |
| | | ing | ing | | ing | ing |
| | Ini- | paper- | paper- | Ini- | paper- | paper- |
| | tial | feeding | feeding | tial | feeding | feeding |
| Example 2-1 | 2 | 3 | 3 | 3 | 3 | 3 |
| Example 2-2 | 2 | 3 | 2 | 3 | 3 | 3 |
| Example 2-3 | 1 | 2 | 1 | 2 | 3 | 3 |
| Example 2-4 | 1 | 2 | 1 | 2 | 3 | 3 |
| Example 2-5 | 1 | 2 | 1 | 2 | 3 | 3 |
| Example 2-6 | 1 | 2 | 1 | 2 | 3 | 2 |
| Example 2-7 | 1 | 2 | 1 | 2 | 2 | 2 |
| Comparative | 4 | 5 | 4 | 5 | 6 | 5 |
| Example 2-1 | | | | | | |
| Comparative | 4 | 5 | 4 | 5 | 6 | 5 |
| Example 2-2 | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-094022, filed Apr. 30, 2014, which is hereby incorporated by reference herein in its entirety.

What is claimed is:

1. An electrophotographic photosensitive member comprising:
a support; and
a photosensitive layer formed on the support,
wherein the photosensitive layer comprises a gallium phthalocyanine crystal comprising a compound having a structure in which a 7-membered ring and a 5-membered ring are condensed to each other within the crystal.

2. The electrophotographic photosensitive member according to claim 1, wherein the compound having a structure in which a 7-membered ring and a 5-membered ring are condensed to each other is an azulene compound.

3. The electrophotographic photosensitive member according to claim 2, wherein the azulene compound is a compound represented by the following formula (1): 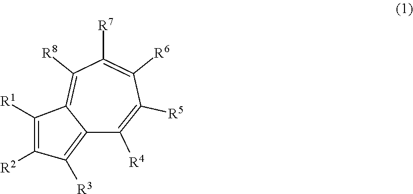
wherein R¹ to R⁸ each independently represent a group selected from the group consisting of a hydrogen atom, an alkyl group, a formyl group, an acetyl group, an alkoxy group, an alkylthio group, an alkoxysulfonyl group, a thiocyano group, a sulfo group, a sodium sulfonate group, a cyano group and a halogen atom.

4. The electrophotographic photosensitive member according to claim 3, wherein at least one of the R¹ to R⁸ is a formyl group, a sodium sulfonate group or an alkoxysulfonyl group.

5. The electrophotographic photosensitive member according to claim 3, wherein the compound represented by the formula (1) is a compound represented by the following formula (2) or a compound represented by the following formula (3): 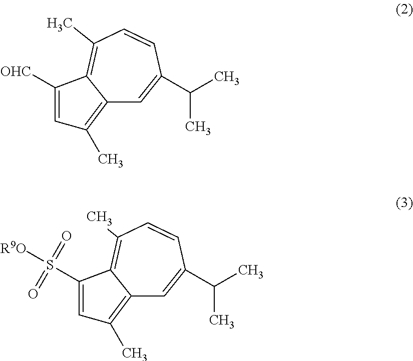
wherein R⁹ represents an alkyl group having 1 to 4 carbon atoms.

6. The electrophotographic photosensitive member according to claim 1, wherein the gallium phthalocyanine crystal is a gallium phthalocyanine crystal further comprising N,N-dimethylformamide or/and N-methylformamide within the crystal.

7. The electrophotographic photosensitive member according to claim 1, wherein the gallium phthalocyanine crystal is a hydroxygallium phthalocyanine crystal.

8. The electrophotographic photosensitive member according to claim 7, wherein the hydroxygallium phthalocyanine crystal is a hydroxygallium phthalocyanine crystal having peaks at Bragg angle 2θ of 7.4°±0.3° and 28.3°±0.3° in X-ray diffraction using CuKα radiation.

9. The electrophotographic photosensitive member according to claim 1, wherein a content of the compound having a structure in which a 7-membered ring and a 5-membered ring are condensed to each other in the gallium phthalocyanine crystal is 0.01% by mass or more and 3% by mass or less.

10. The electrophotographic photosensitive member according to claim 1, wherein the photosensitive layer is a laminated type photosensitive layer having a charge generating layer and a charge transporting layer formed on the charge generating layer, and
wherein the charge generating layer comprises the gallium phthalocyanine crystal comprising a compound having a structure in which a 7-membered ring and a 5-membered ring are condensed to each other within the crystal.

11. A process cartridge comprising:
the electrophotographic photosensitive member according to claim 1; and
at least one unit selected from the group consisting of a charging unit, a developing unit, a transfer unit and a cleaning unit,
the electrophotographic photosensitive member and the at least one unit being integrally supported,
wherein the process cartridge is detachably mountable to an electrophotographic apparatus main body.

12. An electrophotographic apparatus comprising the electrophotographic photosensitive member according to claim 1, and a charging unit, a exposing unit, a developing unit and a transfer unit.

13. A gallium phthalocyanine crystal comprising a compound having a structure in which a 7-membered ring and a 5-membered ring are condensed to each other within the crystal.
